(19) United States
(12) Patent Application Publication
(10) Pub. No.: US 2008/0027608 A1
(43) Pub. Date: Jan. 31, 2008

(54) Operating system for a vehicle

(75) Inventors: Hermann Kuenzner, Freising (DE); Georg Friedrich, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/826,980

(22) Filed: Jul. 19, 2007

Related U.S. Application Data
(63) Continuation of application No. PCT/EP06/00154, filed on Jan. 11, 2006.

(30) Foreign Application Priority Data
Jan. 21, 2005 (DE) 10 2005 002 900.0

(51) Int. Cl. B60R 16/02

(52) U.S. Cl. 701/36

(57) ABSTRACT

In the case of an operating system for a vehicle, having an arbitrarily operable operating component for a first function triggerable during the vehicle operation and for a second function triggerable upon and/or after the termination of the operation of the vehicle instead of the first function, information concerning the second function can be indicated on a display device upon the termination of the operation even before the second function is triggered.

### CROSS-REFERENCE TO RELATED APPLICATIONS

This application is a continuation of PCT International Application No. PCT/EP2006/000154, filed on Jan. 11, 2006, which claims priority under 35 U.S.C. §119 to German Application No. 10 2005 002 900.0, filed Jan. 21, 2005, the entire disclosures of which are expressly incorporated by reference herein.

### BACKGROUND AND SUMMARY OF THE INVENTION

The invention relates to an operating system for a vehicle and, more particularly, to an operating system for a vehicle having an arbitrarily operable operating component for a first function triggerable during vehicle operation and for a second function triggerable upon and/or after termination of operation of the vehicle instead of the first function.

An operating system of this type exists in almost every vehicle. Preferably, the vehicle is a motor vehicle. The addressed function may be, for example, the operation of a vehicle fan for ventilating the vehicle interior or a trip meter reset device.

Some functions are necessary or meaningful only during the driving operation, for example, the operation of an electrical seat heater. Other functions, in turn, can be triggered only upon and/or after the operation of the vehicle. These include, for example, the utilization of the residual heat of the cooling system, which can be activated by a corresponding operating component and during which warm air is supplied to the vehicle interior by way of a blower fan.

Finally, a system of the above-mentioned type is also known, where two different functions are to be triggered by way of a single operating component. This occurs, on the one hand, during the driving operation and, on the other hand, following the driving operation. A typical example is the turn signal switch, which switches the parking light on one vehicle side when the vehicle is parked.

However, in the case of the known operating systems, it cannot be recognized that it is possible to trigger a second function after the end of the operation; let alone, which function it is that may be triggered.

The present invention provides an operating system whereby the vehicle user is informed in a clear and unambiguous manner, and at low expenditures, which function is available to him after parking the vehicle. The present invention, moreover, clearly and unambiguously facilitate the triggering of this function.

According to the present invention, an operating system is provided for an operating system for a vehicle having an arbitrarily operable operating component for a first function triggerable during vehicle operation and for a second function triggerable upon and/or after termination of operation of the vehicle instead of the first function. Information concerning the second function is indicatable on a display device at the end of the vehicle operation even before the function is triggered.

The present invention differs significantly from an operating system in which, as indicated above, a turn signal switch is provided. In the case of a turn signal switch, it can, as a rule, not be recognized whether, and possibly how, the second function can actually be triggered at the end of the operation of the vehicle. If the switch is in the operative position differing from the neutral position and the second function can, in fact, be triggered, then the parking light will be switched on immediately and without any special cause. As a rule, this cannot even be recognized until the vehicle user has left the vehicle and sees the parking light.

In contrast, the present invention advantageously allows for the vehicle user, means of the display device and without acting deliberately and on his own, to be supplied with information concerning the second function at the end of the vehicle operation before the second function is triggered. For its triggering, this second function requires a deliberate operation of the operating component.

Advantageous embodiments of the invention are described herein. Thus, the display device can be arranged physically close to the operating component, which facilities the operation.

Furthermore, information concerning the first function can also displayed on the display device before the end of the operation. The vehicle user thereby becomes accustomed to the display device.

Finally, the information concerning the end of the operation can be obtained by way of the position of an ignition switch. When the vehicle user parks the vehicle, which he normally does by operating the ignition switch, he receives information concerning the second function. He will have the favorable impression that he himself has switched on this information.

A special characteristic of the invention is the fact that the information displayed by way of the display device is limited with respect to time. This may be a constant “time delay” of a few seconds following the end of the vehicle operation and/or an activating of the display device that lasts until the driver leaves the vehicle. “Or” means that the two measures are provided as alternatives; “and” means that the two measures are both provided and the display device is deactivated as a function of which event occurs earlier (after the end of the time delay or upon leaving the car).

Other objects, advantages and novel features of the present invention will become apparent from the following detailed description of the invention when considered in conjunction with the accompanying drawings.

### BRIEF DESCRIPTION OF THE DRAWINGS

FIGS. 1a-1c are diagrammatic views of a first embodiment of the operating system according to the invention; and

FIGS. 2a-2c are diagrammatic views of a second embodiment according to the invention.

### DETAILED DESCRIPTION OF THE DRAWINGS

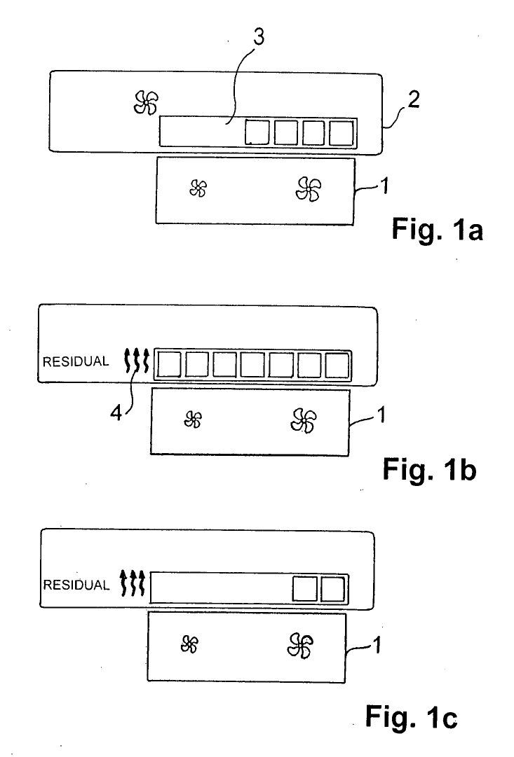

The embodiment of FIG. 1 illustrates an operating system in which the rotational speed of a blower (not shown) can be adjusted by way of a rocker switch 1 during the driving operation. By way of the blower, the air supply to the vehicle occupant compartment can be adjusted. This will b referred to as a “first function” in the following. This operation is illustrated in FIG. 1a). On a display device 2, the respective rotational speed is symbolized in the manner of a bar chart 3.

When the vehicle (also not shown) is switched off, i.e. by, for example, interrupting the ignition circuit, the display in the display device 2 will change. The letters “REST” and a flow symbol 4 (see FIG. 1b) appear. The vehicle user thereby receives the information that the utilization of the residual heat can take place in the climate control system as the second function.

When the vehicle user now operates the rocker switch 1, he can thereby control the second function and, as much as possible, supply warm air into the occupant compartment by way of the same blower even after the vehicle was a parked. The amount of the air supply is again symbolized by means of a bar chart 3.

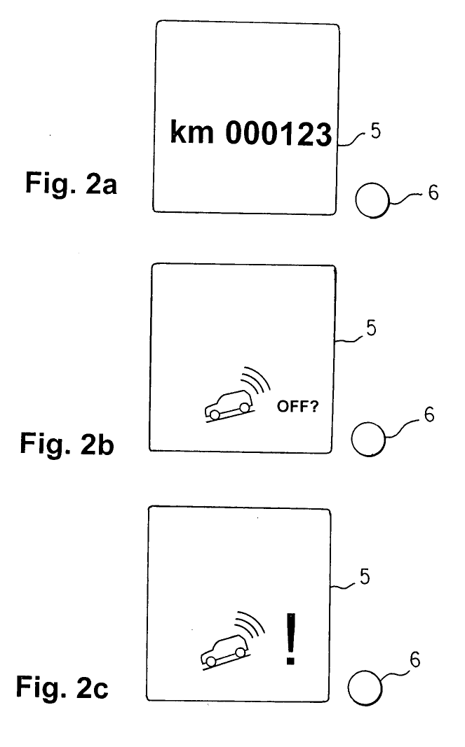

The embodiment of FIG. 2 shows the possibility of switching off a tilt alarm of the vehicle. This becomes possible without requiring the hidden operation on a vehicle key customary today.

The switching-off of the tilt alarm, which is normally used for antitheft purposes, is required, for example, when the vehicle is parked in a duplex garage or is transported on a ferry and therefore subject to normal tilting.

Three phases are again shown in the example. Any display capable of indicating the function by way of text or symbols can be used as the display device. In the example, it is a trip odometer 5 which, in the driving operation, reflects the route covered since the last resetting of the odometer by way of a pressure switch 6, as illustrated in FIG. 2a).

FIG. 2b shows the display device 5 during and after the switching-off of the vehicle. The tilt alarm suppression, which can be triggered by way of the pressure switch 6 after the switching-off of the vehicle, is symbolically shown as the second function. This function is symbolized by a pictograph and the question “off”?

When the pressure switch 6 is operated, the alarm is suppressed and this function is indicated in the display (see FIG. 2c). By way of the invention, it therefore becomes possible to indicate and, as required, change the alarm status.

On the whole, costs and space can be saved by use of the invention because existing operating components have a double use. In addition, the operation can be simplified for the vehicle user because the function will be offered only if it is actually available.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An operating system for a vehicle, comprising:
an operating component that is arbitrarily operable for a first function activatable during operating of the vehicle and for a second function activatable upon and/or after termination of operation of the vehicle instead of the first function;
a display device, the display device indicating information concerning the second function upon termination of the vehicle operation prior to the activation of the second function.

2. The operating system according to claim 1, wherein the display device and operating component are operatively configured in close physical proximity to one another.

3. The operating system according to claim 1, wherein information concerning the first function is indicatable on the display device before the termination of the vehicle operation.

4 The operating system according to claim 2; wherein information concerning the first function is indicatable on the display device before the termination of the vehicle operation.

5. The operating system according to claim 1, wherein termination of the vehicle operation is recognizable from a position of an ignition switch of the vehicle.

6. The operating system according to claim 2, wherein termination of the vehicle operation is recognizable from a position of an ignition switch of the vehicle.

7. The operating system according to claim 3, wherein termination of the vehicle operation is recognizable from a position of an ignition switch of the vehicle.

8. The operating system according to claim 4, wherein termination of the vehicle operation is recognizable from a position of an ignition switch of the vehicle.

9. The operating system according to claim 1, wherein activation of the display device occurs only for a predefined limited amount of time upon the termination of the vehicle operation.

10. The operating system according to claim 5, wherein activation of the display device occurs only for a predefined limited amount of time upon the termination of the vehicle operation.

11. A method of informing an operator of a vehicle concerning first and second functions of the vehicle controlled by an operating component that is arbitrarily operable, the first function being activatable during operation of the vehicle and the second function being activatable upon and/or after termination of the operation of the vehicle in place of the first function, the method comprising the acts of:
determining the termination of the operation of the vehicle; and
indicating on a display information concerning the second function upon detecting the termination and before activation of the second function.

12. The method according to claim 11, further comprising the act of:
indicating on the display information concerning the first function before the termination of the vehicle operation is detected.

13. The method according to claim 11, wherein the act of detecting the termination is performed by recognizing a termination position of an ignition switch of the vehicle.

14 The method according to claim 11, wherein the act of indicating the information concerning the second function is performed for a predefined time period upon detecting the termination of the operation of the vehicle.
